(19) United States
(12) Patent Application Publication
(10) Pub. No.: US 2023/0192725 A1
(43) Pub. Date: Jun. 22, 2023

(54) NOVEL ORGANO-MAGNESIUM COMPOUNDS AND THEIR USE

(71) Applicant: LANXESS Organometallics GmbH, Bergkamen (DE)

(72) Inventors: Thorsten Holtrichter-Roessmann, Ahlen (DE); Claus Guenter Liedke, Werne (DE); Julia Felicitas Schwarz, Laarkirchen (AT)

(73) Assignee: LANXESS Organometallics GmbH, Bergkamen (DE)

(21) Appl. No.: 17/925,929

(22) PCT Filed: May 18, 2021
(86) PCT No.: PCT/EP2021/063178

§ 371 Date: Nov. 17, 2022

(30) Foreign Application Priority Data
May 20, 2020 (EP) 20175740.8

(51) Int. Cl. C07F 3/02

(52) U.S. Cl. CPC C07F 3/02

(57) ABSTRACT

The present invention relates to novel organo-magnesium compounds obtained by reaction of dialkyl-magnesium compounds and carbodiimides and their use as precursors for the preparation of further magnesium compounds and catalysts.

The present invention relates to novel organo-magnesium compounds obtained by reaction of dialkyl-magnesium compounds and carbodiimides and their use as precursors for the preparation of further magnesium compounds and catalysts.

Dialkyl-magnesium compounds are used in a wide variety of chemical reactions. As reagents, these compounds can be used for the alkylation of ketones and the alkylation of metal halides or oxides to the corresponding metal alkyls. As catalysts, dialkyl-magnesium compounds were successfully employed in the dimerization and polymerization of olefins (GB 1,251,177), the polymerization of epoxides (US 3,444,102 A) and the preparation of telomers (US 3,742,077 A). While suitable in similar reaction types like Grignard reagents, dialkyl-magnesium compounds, owing to differences in electronic and steric properties, are more reactive than Grignard reagents toward certain types of compounds.

Important dialkyl-magnesium compounds include n-butyl-n-octyl-magnesium (BOMAG), n-butyl-ethyl-magnesium (BEM), n-butyl-sec-butyl-magnesium (DBM), di-n-butyl-magnesium (DnBM) di-n-hexyl-magnesium (DHM), di-n-octyl-magnesium (DOM). They are typically prepared by reaction of alkyl chlorides with magnesium powder in an inert solvent in the presence of organo-aluminum compounds which activate the magnesium and remove residual traces of water (see US 4,128,501 A, US 4,207,207 A, US 3,737,393 and DE2943357 C2.

Generally, organo-magnesium compounds are prone to hydrolysis and oxidation upon exposure to moisture and air and thus require handling under an inert atmosphere.

Further, application of diorgano-magnesium compounds is encumbered by the fact that many of them are either solids or highly viscous liquids. This problem is generally overcome either by dissolving the compounds in an inert hydrocarbon solvent or by solvating them. However, some diorgano-magnesium compounds, in particular those with straight chain alkyl groups with four or less carbon atoms are insoluble in hydrocarbon solvents and thus require solubilizing agents such as alkyl-lithium compounds, (US 3,742,077), dialkyl-zinc compounds (US 3,444,102), alkali metal hydrides (US 3,655,790), organo-aluminum compounds (US 3,737,393 and US 3,028,319), or a combination of different dialkyl-magnesium compounds in hydrocarbon solvents (US 4,069,267, US 4,127,507, US 4,207,207 and US 4,222,969)

Solvation involves the use of an ether or other organic Lewis base molecule to coordinate to the magnesium atom, thus yielding a hydrocarbon soluble complex. The solvated form, however, is undesirable since solvation significantly inhibits the reactivity of the organo-magnesium compound.

Solvation typically also reduces the viscosity of reaction mixtures which otherwise are difficult to handle, in particular where mechanical mixing is required.

This problem can partially be solved by the use of chloro-aryl solvents which form low viscous suspensions of insoluble compounds (US 3,264,360).

Other attempts to reduce viscosity of solutions comprising organo-magnesium compounds are disclosed in W099/09035 where tetra-orthosilicate is used in amounts of up to 11 mol-% based on the magnesium content as well as in in US 4,299,781 and US 4,547,477.

The disadvantage of known means to reduce viscosity and/or to improve solubility are that they go hand in hand with either reduced reactivity of the organo-magnesium compounds or introduction of undesired components like halides or metals other than magnesium which in a further step might negatively affect catalyst stability e.g. where organo-magnesium compounds are used as precursor materials.

Where, for example, dialkyl-magnesium and magnesium alkoxide solutions are used to prepare magnesium chloride carriers for titanium-bearing polyolefin catalysts it is advantageous to have a low content of or preferably no aluminum alkyl or aluminum alkoxide. The reason for that is that the magnesium chloride crystallites would be contaminated with aluminum chloride which upon subsequent treatment of the resulting catalyst with an aluminum alkyl co-catalyst would release aluminum chloride thus causing degradation of the magnesium chloride crystal lattice.

Such degraded magnesium chloride carriers lower the conversion efficiency of the whole catalyst system.

In view of the above there was still a need for organo-magnesium compounds which are readily soluble in particular in non-coordinating solvents, capable of stabilizing solutions even at high concentration while showing significantly reduced viscosity compared to comparable solutions of known diorgano-magnesium compounds.

In a further aspect such organo-magnesium compounds should be accessible with low or no content of halides and/or compounds of metals other than magnesium.

There are now provided novel organo-magnesium compounds obtainable by reacting compounds of formula (I) with compounds of formula (II)

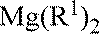

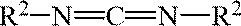

wherein
R¹ each independently of the other residue R¹ present in the compound of formula (I) denotes alkyl which is either not or once substituted by phenyl or and
R² each independently of the other residue R² present in the compound of formula (II) denotes alkyl which is either not or once substituted either by optionally substituted phenyl or N(R³)₂, or denotes optionally substituted phenyl or denotes Si(R³)₃, wherein in the aforementioned formulae R³ is alkyl or optionally substituted phenyl.

The scope of the invention encompasses all combinations of substituent definitions, parameters and illustrations set forth above and below, either in general or within areas of preference or preferred embodiments, with one another, i.e., also any combinations between the particular areas and areas of preference.

It is known to those skilled that diorgano-magnesium compounds of formula (I) in particular in non-coordinating solvents typically form linear polymers with tetrahedral magnesium centers, each surrounded by four bridging alkyl groups. With increasing concentration their handling becomes difficult due to high viscosity.

It is a major finding of the invention that by reaction of compounds of formula (I) with compounds of formula (II) the viscosity in non-coordinating solvents is significantly decreased thereby allowing easy handling of even higher concentrated solutions without affecting their overall suitability for the intended purposes.

Therefore, the invention further encompasses solutions of the novel organo-magnesium compounds in non-coordinating solvents and the use of compounds of formula (II) as viscosity modifier of compounds of formula (I) in non-coordinating solvents.

Whenever used herein the terms “including”, “for example” and “such as” are meant in the sense of “including but without being limited to” or “for example without limitation”, respectively.

As used herein the term “non-coordinating solvent” means that the solvent molecules do not contain oxygen, sulfur or nitrogen atoms. For example non-coordinating solvents include aliphatic solvents such as pentanes, hexanes, heptanes, octanes, nonanes, decanes, undecanes, dodecanes, each of the aforementioned in any possible isomeric pure form or in isomeric mixtures, mineral oils or any mixture of the aforementioned aliphatic solvents. Preferred non-coordinating solvents include n-pentane, iso-pentane, pentanes, n-hexane, iso-hexane, hexanes, n-heptane, isoheptane, heptanes.

As used herein, and unless specifically stated otherwise “alkyl” may be straight-chained, cyclic either in part or as a whole, branched or unbranched, as one of ordinary skill in the art knows however, limited depending on the number of carbon atoms.

Preferably, “alkyl” denotes Ci-Cis-alkyl even more preferably Ci-Cs-alkyl which either not or once substituted by phenyl, preferably not substituted. The index at the carbon atoms indicates the number carbon atoms excluding the carbon atoms of optionally present phenyl substituents. Specific examples of Ci-Cs-alkyl are methyl, ethyl, n-propyl, isopropyl, n-butyl, tert-butyl, n-pentyl, cyclohexyl, n-hexyl, methylcyclohexyl, n-heptyl, n-octyl, isooctyl, n-decyl, whereby methyl, ethyl, isobutyl, n-butyl, n-hexyl and n-octyl are preferred.

As used herein, and unless specifically stated otherwise “optionally substituted phenyl” denotes phenyl or phenyl which is once, twice or three times substituted by phenyl or Ci-Cs-alkyl. Specific examples of optionally substituted phenyl include phenyl, 2-methylphenyl, 3-methylphenyl, 4-methylpheny, 2,4-dimethylphenyl, 2,6-dimethylphenyl, 2,4,6-trimethylphenyl, 4-tert-butylphenyl.

Preferred compounds of formula (I) are n-butyl-n-octyl-magnesium (BOMAG), n-butyl-ethyl-magnesium (BEM), n-butyl-sec-butyl-magnesium (DBM), di-n-butyl-magnesium (DnBM) di-n-hexyl-magnesium (DHM) and di-n-octyl-magnesium (DOM).

Preferred compounds of formula (II) are N,N′-dicyclohexylcarbodiimide, diisopropylcarbodiimide, and 1-ethyl-3-(3-dimethylaminopropyl)carbodiimide, 1,3-bis(trimethylsilyl)carbodiimide, bis(4-methylphenyl)carbodiimide, N,N′-bis(2-methylphenyl)carbodiimide, whereby N,N′-dicyclohexylcarbodiimide is even more preferred.

The reaction of compounds of formula (I) with compounds of formula (II) to obtain the novel organo-magnesium compounds according to the invention are for example but preferably performed in non-coordinating solvents.

For example the compounds of formula (II) are added either neat or as a solution in a non-coordinating solvent to solutions of compounds of formula (I) in the same or different non-coordination solvents or vice versa.

The process can either be performed batchwise or continuously, preference being given to batchwise performance.

The reaction times in batch processes and the residence time in continuous processes are for example from 30 seconds to 24 hours, preferably from 5 minutes to 1 hour.

The process according to the invention can be performed, for example, in any reactor allowing such kind of reactions, for example a tube reactor with mixing nozzle in case of continuous processes or a stirred tank for batch processes.

The process according to the invention is performed, for example, at temperatures of -80 to 100° C., preferably at temperatures of -20 to 50° C.

The reaction can be carried out for example at reaction pressures of 10 hPa to 10 MPa, preferably from 200 hPa to 1 MPa, more preferably at ambient pressure.

The molar ratio between compounds of formula (I) and compounds of formula (II) is preferably from 1.0 to 200.0, preferably from 2.0 to 100.0 more preferably from 5.0 to 80.0 and yet even more preferably from 20.0 to 50.0.

Where solutions are desired, the concentration of the novel organo-magnesium compounds in non-coordinating solvents is for example from 5 to 60 wt.-%, preferably from 10 to 50 wt.-% and even more preferably from 20 to 50 wt.-%, yet even more preferably from 25 to 40 wt.-%.

As used herein the concentration of the solution in wt.-% is indicated such that its magnesium content corresponds to the magnesium content of an equivalent amount of diorgano magnesium compound it was prepared from.

An example includes a 30 wt.-% solution obtained by reaction of a 30 wt.-% solution n-butyl-n-octyl magnesium in heptane with 2.5 mol-% of dicyclohexylcarbodiimide.

Without wanting to be bound by theory the novel organo-magnesium compounds obtainable by reaction of compounds of formula (I) with compounds of formula (II) comprise at least a structural unit of formula (III) or formula (IV)

Without wanting to be bound by theory the novel organo-magnesium compounds obtainable by reaction of compounds of formula (I) with compounds of formula (II) comprise at least a structural unit of formula (III) or formula (IV)

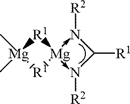

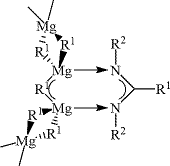

wherein R¹ and R² have the meaning including their preferences as set forth above, the arrows denote coordinative bonds from magnesium to nitrogen or the amidinate group the other solid, bold or dashed bonds denote covalent bonds or, where magnesium and alkyl residues R¹ are involved a three center two electron bond and wherein at least one of the solid bonds for each magnesium showing no bound element or group is linking to a residue R¹ or both solid bonds are linking to a further chain element MgR¹₂ (as it is analogously the case in diorgano-magnesium compounds like dimethyl magnesium).

It was found that the organo-magnesium compounds according to the invention as well as their solutions in non-coordinating solvents are particularly useful to be employed as a substitute for compounds of formula (I) they were made from but having lower viscosity thus making their handling much easier and allowing higher concentrations to be used.

In particular the organo-magnesium compounds according to the invention may be employed in a process for the preparation of magnesium alcoholates, preferably those of formulae (III) and (IV)

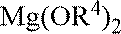

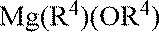

wherein
R⁴ each independently of the other residue R⁴ present in the compounds of formulae (III) and (IV) denotes alkyl which is either not or once substituted by phenyl
the process comprising at least the step of
   a) reacting the organo-magnesium compounds according to the invention with an alcohol, preferably an alcohol of formula (V) 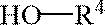
   wherein R⁴ has the same meaning as defined for formulae (III) and (IV) above.

The organo-magnesium compounds according to the invention may further be employed in a process for the preparation of magnesium chloride the process comprising at least the steps of
a) reacting the organo-magnesium compounds according to the invention with an alcohol, preferably those of formula (V) to obtain the respective magnesium alcoholates, preferably those of formulae (III) or (IV) and
a) reacting the magnesium alcoholates obtained according to step a) with a chloride source to magnesium dichloride

Alternatively, magnesium chloride may directly be obtained by reacting the organo-magnesium compounds according to the invention with a chloride source.

The analogous reaction using compounds of formula (I) as a starting material are known to those skilled in art.

Suitable alcohols include 2-ethyl-hexanol, methanol, ethanol, 2-methyl-1-pentanol, 2-ethyl-1-butanol, 2-ethyl-1-pentanol, 2-ethyl-4-methyl-1-pentanol, 2-propyl-1-heptanol, 2-methyl-1-hexanol, 2-ethyl-5-methyl-1-octanol. The respective residues R⁴ are 2-ethyl-hexyl, methyl, ethyl, 2-methyl-1-pentyl, 2-ethyl-1-butyl, 2-ethyl-1-pentyl, 2-ethyl-4-methyl-1-pentayl, 2-propyl-1-heptyl, 2-methyl-1-hexyl and 2-ethyl-5-methyl-1-octyl.

Suitable chloride sources include ethyl aluminum dichloride (EADC), diethyl aluminium chloride (DEAC), ethyl aluminium sesquichloride (EASC), isobutyl aluminium dichloride (IBADIC), diisobutylaluminium dichloride (DIBAC) or mixtures of these, aluminium trichloride, tert-butyl chloride, n- butyl chloride and phthaloyldichloride.

It was found that the compounds of formula (II) employed to form the novel organo-magnesium compounds according to the invention are helpful to reduce viscosity even for further reaction products such as magnesium alcoholates, preferably of those of compounds of formulae (III) and (IV), more preferably of those of formula (IV).

Therefore a further aspect of the invention relates to the use of compounds of formula (II) to reduce the viscosity of magnesium alcoholates, preferably those of formulae (III) and (IV), more preferably of those of formula (IV).

The following examples are intended to illustrate the invention, but without limiting it thereto.

### EXPERIMENTAL

### General

All syntheses were performed under argon or nitrogen and water exclusion. The chemicals used were: dicyclohexylcarbodiimide, (≥ 99 %, Sigma-Aldrich); ethylaluminiumdichloride (EADC, 25.3 wt-% in heptane, LANXESS Organometallics GmbH); butyl-octylmagnesium (BOMAG, 20 wt-% in heptanes, LANXESS Organometallics GmbH), 2- ethylhexanol (≥ 99 %, Merck); n-Heptane (≥ 99 %, Roth); Mol sieve (3 Å, type 562 C, Roth); titanium(IV)chloride (1 mol 1⁻¹ in toluene; Acros Organics); hydrochloric acid (36 wt-%, Analpure), nitric acid (≥ 69.0%; Honeywell) and hydrofluoric acid (48 wt-%, Analpure).

### Viscosity Measurement

The viscosity measurement according to DIN 53019 was slightly adapted to be applicable to pyrophoric compounds.

A LVDV2T* EXTRA Viscosimeter from Brookfield AMATEK including the SSA-K Small Sample Adapter (EZ), the SC4-13T sample chamber , the SX-V80 spindle extension and SC4-18 spindle were used for measuring the viscosity.

Spindle, probe chamber, spindle extension and the Small Sample Adapter were dried and completely free of moisture. The spindle, probe chamber and adapter were placed in the viscosimeter and tempered to 20° C. The probe chamber was removed and completely covered and cleaned with argon for min. 2 minutes. Under argon 7.3 mL of the sample liquid were filled into the probe chamber and the probe chamber with sample placed in the Small Sample adapter. The spindle was completely covered with sample. The probe chamber was closed and constantly covered with a blanket of argon. The measurement was started with app. 10 rpm and the desired measurement range adjusted. The viscosity data was collected after 60 s of constant measurement.

### General Experimental Procedure

A magnesium-dialkyl compound solution was distilled or diluted to the desired concentration and a carbodiimide added. Subsequent stirring at the indicated temperature completed the reaction.

### EXAMPLES

### Example 1

### 1A) BOMAG-DCC 20

To 105.5 g of a 20 wt.-% solution of n-butyl-n-octyl magnesium (BOMAG) in heptanes ( Mg-content = 2.97 wt.-%, Al content = 780 ppm) 0.67 g dicyclohexylcarbodiimide (2.5 mol %) were added at room temperature. An increase of 3° C. was observed and the mixture heated to 50° C. and stirred for 1 hour at this temperature.

### 1B) BOMAG-DCC 25

To 98.18 g of a 25 wt.-% solution of n-butyl-n-octyl magnesium in heptanes (Mg content 3.64 wt.-%, Al content 1017 ppm) 0.78 g dicyclohexylcarbodiimide were added (2.5 mol %) at room temperature. An increase of 3° C. was observed. The reaction was stirred at 50° C. for 1 hour.

### 1C) BOMAG-DCC 30

1278.6 g of a 30 wt.-% solution of n-butyl-n-octyl magnesium in heptanes ( Mg-content 2.97 wt.-%,) were concentrated by distillation of heptanes to 842.4 g to yield a 30.19 % solution of n-butyl-n-octyl magnesium in heptanes. To this solution a solution of 8.06 g dicyclohexylcarbodiimide in 9.0 g heptanes was added and the reaction mixture stirred for 60 minutes at room temperature. The solution remains clear and colorless.

### 1D) BOMAG-DCC 35

To 84.97 g of a 35 wt.-% solution of n-butyl-n-octyl magnesium in heptanes (Mg content 5.25 wt.-%, Al content 1374 ppm) 0.95 g dicyclohexylcarbodiimide were added (2.5 mol %) at room temperature. An increase of 3° C. was observed. The reaction was stirred at 50° C. for 1 hour.

The viscosities were measured according to the method indicated above and the results are given in table 1.

TABLE 1

Viscosities of BOMAG-DCC-solutions

| Example | Mg-content [m/m] | BOMAG content* [m/m] | Viscosity at 20° C. [mPa*s] |
|---|---|---|---|
| 1a) | 3.02 | 20.7 | 12.6 |
| 1b) | 3.62 | 24.8 | 21.5 |
| 1c) | 4.37 | 29.9 | 48.9 |
| 1d) | 5.22 | 35.8 | 95.3 |

*BOMAG content is calculated from measured Mg-content.** DCC was used 2.5 mol% calculated on measured Mg-content

### Example 2

### 2A) BEM-DCC 20

To 105.9 g of a 20 wt.-% solution of n-butyl-ethyl-magnesium (BEM) in heptanes (Mg-content = 4.48 wt.-%, Al content = 956 ppm) 1.01 g dicyclohexylcarbodiimide (2.5 mol %) were added at room temperature. An increase of 3° C. was observed and the mixture heated to 50° C. and stirred for 1 hour at this temperature.

### 2B) BEM-DCC 30

To 793.4 g of an 32 wt.-% solution of n-butyl-ethyl-magnesium in heptanes (Mg content 6.99 wt.-%) 14.12 g dicyclohexylcarbodiimide (3 mol %) dissolved in 27.5 g heptanes were added at room temperature and stirred for 60 minutes.

### 2C) BEM-DCC 30

To 1207.5 g of a 20 wt.-% solution of n-butyl-ethyl-magnesium in heptanes (Mg content 4.48) a solution of 11.48 g dicyclohexylcarbodiimide (2.5 mol %) dissolved in 7.0 g heptanes were added at room temperature. The temperature increased by 6° C. and the reaction mixture was concentrated to 30 wt.-% by distillation in vacuum.

The viscosities were measured according to the method indicated above and the results are given in table 2.

TABLE 2

Viscosities of BEM-DCC-solutions

| Example | Mg-content [m/m] | BEM content* [m/m] | Viscosity [mPa*s] |
|---|---|---|---|
| 2a) | 4.48 | 20.4 | 26.9 |
| 2b) | 6.62 | 30.1 | 66.9 |
| 2c) | 6.67 | 30.3 | 109.0 |

*BEM content is calculated from measured Mg-content.** DCC was used 2.5 or 3 mol% calculated on measured Mg-content

### Example 3

### 3A) BOMAG-DCC Stock Solution (1:1)

To 43.3 g of a 32 wt.-% solution of n-butyl-n-octyl magnesium in heptanes (Mg content 4.66 wt.-%, 0.083 mol) 17.12 g dicyclohexylcarbodiimide ( 0.083 mol) in 1 g heptanes were added and stirred at 50° C. for 60 minutes. The solution was clear and yellowish. 1.63 g of this solution and 1 g heptanes was added to 46.0 g of an 32 wt.-% solution of n-butyl-n-octyl magnesium in heptanes (Mg content 4.66 wt.-%, 0.088 mol) and stirred at 50° C. for 60 minutes.

### 3B) BOMAG-DCC Stock Solution (2:1)

To 45.4 g of a 32 wt.-% solution of n-butyl-n-octyl magnesium in heptanes (Mg content 4.66 wt.-%, 0.087 mol) 8.97 g dicyclohexylcarbodiimide ( 0.043 mol) in 1 g heptanes were added and stirred at 50° C. for 60 minutes. The solution was clear and yellowish. 3.62 g of this solution was added to 59.4 g of a 32 wt.-% solution of n-butyl-n-octyl magnesium in heptanes (Mg content 4.66 wt.-%, 0.1138 mol) and stirred at 50° C. for 60 minutes.

The viscosities were measured according to the method indicated above and the results are given in table 3.

TABLE 3

Viscosities of stock solutions of BOMAG-DCC

| Example | Mg-content [m/m] | BOMAG content* [m/m] | Viscosity [mPa*s] |
|---|---|---|---|
| 3a) | 5.02 | 34.4 | 60.0 |
| 3b) | 4.96 | 34.0 | 62.7 |

*BOMAG content is calculated from Mg-content.

### Comparative Examples 4a) to 4f)

Standard solutions of n-butyl-n-octyl magnesium in heptanes were prepared as comparison by dilution of a 20 wt.-% solution of n-butyl-n-octyl magnesium with heptanes or removal of heptane by distillation.

The viscosities were measured according to the method indicated above and the results are given in table 4.

TABLE 4

Viscosities of BOMAG-solutions

| Example | Mg-content [m/m] | BOMAG content* [m/m] | Viscosity [mPa*s] |
|---|---|---|---|
| 4a) | 5.25 | 36.1 | 305.3 |
| 4b) | 4.32 | 29.7 | 142.6 |
| 4c) | 3.64 | 25.0 | 72.4 |
| 4d) | 2.97 | 20.4 | 40.2 |
| 4e) | 2.22 | 15.3 | 17.1 |
| 4f) | 1.50 | 10.3 | 8.3 |

*BOMAG content is calculated from Mg-content.

It is apparent that the examples according to the invention exhibit a far lower viscosity at the same concentration of diorganomagnesium compound compared to the standard material or a much higher concentration at the same viscosity level even though only a small amount of carbodiimide was added.

### Examples 5a) and 5b): Synthesis of Magnesiumdichloride - MgCl₂

The a solution of BOMAG-DCC 20 according to example 1a) (example 5a) or BOMAG (example 5b) in an amount that it comprised 8.55 mmol of BOMAG or the modified organomagnesium compounds BOMAG-DCC were introduced into a 25 ml two neck round bottom flask and 2-ethylhexanol (17.2 mmol) was added dropwise within 30 min with stirring in the glovebox. Due to the exothermic nature of the reaction, the mixture was cooled and kept at a temperature of about 10° C. During reaction the viscosity decreased and after approx. 75 % of conversion the viscosity of the mixture started to increase again. After full addition, the reaction mixture was stirred for 40 min at room temperature.

To convert the resulting alcoholate into the desired magnesium chloride EADC (8.55 mmol) was heated to 60° C. The addition of the alcoholate solution to EADC was done dropwise within 30 minutes and a white precipitate was formed. After 1 h stabilization time the MgCl₂ was separated by centrifugation (Thermo Megafuge 1.0R, 1500 rpm, 5 min). The carrier was washed twice with 3 ml n-heptane at room temperature and diluted at the end with 5 ml n-heptane to form a suspension of Magnesium chloride.

The magnesium chlorides obtained according to examples 5a) and 5b) were employed as carrier materials for Ziegler-Natta-catalysts which themselves were used as catalyst in ethylene polymerization. Both magnesium chlorides showed similar results proving that the carbodiimide addition has no negative effect on magnesium chloride quality and applicability.

### Example 6

### 6A) BOMAG-BTMSCD 20

To 20.32 g of a 20.4 wt.-% solution of n-butyl-n-octyl magnesium in heptanes (Mg-content = 2.97 wt.-%, Al-content = 780 ppm) 0.066 g bis(trimethylsilyl)-carbodiimide (1.4 mol %) were added at room temperature and the mixture heated to 50° C. and stirred for 0.5 hours at this temperature.

### 6B) BOMAG-BTMSCD 20

To 28.01 g of a 20 wt.-% solution of n-butyl-n-octyl magnesium in heptanes (Mg-content = 2.97 wt.-%, Al-content = 780 ppm) 0.139 g bis(trimethylsilyl)-carbodiimide (2.1 mol %) were added at room temperature. An increase of 1° C. was observed, the mixture heated to 50° C. and stirred for 0.5 hour at this temperature.

### 6C) BOMAG-BTMSCD 20

To 26.4 g of a 20 wt.-% solution of n-butyl-n-octyl magnesium in heptanes (Mg-content = 2.97 wt.-%, Al-content = 780 ppm) 0.155 g bis(trimethylsilyl)-carbodiimide (2.5 mol %) were added at room temperature. An increase of 1° C. was observed, the mixture heated to 50° C. and stirred for 0.5 hour at this temperature.

### 6D) BOMAG-BTMSCD 20

To 19.4 g of a 20 wt.-% solution of n-butyl-n-octyl magnesium in heptanes (Mg-content = 2.97 wt.-%, Al-content = 780 ppm) 0.147 g bis(trimethylsilyl)-carbodiimide (3.3 mol %) were added at room temperature. An increase of 1° C. was observed, the mixture heated to 50° C. and stirred for 0.5 hour at this temperature.

### 6E) BOMAG-BTMSCD 35

To 19.1 g of a 35 wt.-% solution of n-butyl-n-octyl magnesium in heptanes (Mg-content = 5.13 wt.-%, Al-content = 1300 ppm) 0.184 g bis(trimethylsilyl)-carbodiimide (2.4 mol %) were added at room temperature. An increase of 1° C. was observed, the mixture heated to 50° C. and stirred for 0.5 hour at this temperature.

### 6F) BOMAG-BTMSCD 35

To 19.03 g of a 35 wt.-% solution of n-butyl-n-octyl magnesium in heptanes (Mg-content = 5.13 wt.-%, Al-content = 1300 ppm) 0.093 g bis(trimethylsilyl)-carbodiimide (1.2 mol %) were added at room temperature. An increase of 1° C. was observed and the mixture heated to 50° C. and stirred for 0.5 hour at this temperature.

For comparison, the viscosities of the 20 and 35 wt.-% solution of n-butyl-n-octyl magnesium in heptanes employed for examples 6a) to 6f were measured as well (see entries for examples 6g and 6h).

The viscosities were measured according to the method indicated above and the results are given in table 5.

TABLE 5

Viscosities of BOMAG-BTMSCD-solutions

| Example | Mg-content [m/m] | BOMAG content* [m/m] | Viscosity at 20° C. [mPa*s] |
|---|---|---|---|
| 6a) | 2.97 | 20.4 | 14.0 |
| 6b) | 2.97 | 20.4 | 16.2 |
| 6c) | 2.97 | 20.4 | 7.6 |
| 6d) | 2.97 | 20.4 | 5.9 |
| 6e) | 5.13 | 35.1 | 48.0 |
| 6f) | 5.13 | 35.1 | 100.4 |
| 6g)** | 5.13 | 35.1 | 326 |
| 6h)** | 2.97 | 20.4 | 40.2 |

*BOMAG content is calculated from Mg-content.
** for comparison

### Example 7

### 7A) BEM-BTMSCD 30

To 20.13 g of a 33.2 wt.-% solution of n-butyl-ethyl magnesium in heptanes ( Mg-content = 7.3 wt.-%, Al content = 700 ppm) 0.29 g bis(trimethylsilyl)-carbodiimide 2.5 mol %) were added at room temperature, the mixture heated to 50° C. and stirred for 0.5 hour at this temperature. For comparison, the viscosity of the 33.2 wt.-% solution of n-butyl-ethyl magnesium in heptanes employed for example 7a) was measured as well (see entry for example 7b).

The viscosities was measured according to the method indicated above and the results are given in table 6.

TABLE 6

Viscosity of BEM-BTMSCD-solution

| Example | Mg-content [m/m] | BEM content* [m/m] | Viscosity at 20° C. [mPa*s] |
|---|---|---|---|
| 7a) | 7.3 | 20.4 | 47.1 |
| 7b)** | 7.3 | 20.4 | 509.0 |

*BEM content is calculated from Mg-content.
** for comparison

### Example 8

### BOMAG-DCC Solution (1.4 Mol-%)

To 21.11 g of a 35.1 wt.-% solution of n-butyl-n-octyl magnesium in heptanes (Mg content 5.13 wt.-%, 44.6 mmol) 0.129 g dicyclohexylcarbodiimide ( 0.625 mmol) were added and stirred at room temperature for 60 minutes. The solution thus contained 1.4 mol-% calculated on Magnesium.

### Example 9

To 5.706 g (12.04 mmol) of the BOMAG-DCC Solution (1.4 mol-%) prepared according to example 8 in a 50 ml Schlenk-flask, 2.937 g 2-ethylhexanol (22.55 mmol) were added dropwise at 0° C. and thereafter stirred at room temperature for 60 minutes. Thereafter, further 0.0335 g (0.162 mmol) of dicyclohexylcarbodiimide (DCC) were added to increase the total amount of DCC added to 2.74 mol-% calculated on magnesium. The viscosity was measured as indicated above and found to be 61.5 mPa*s at 20° C.

### Example 10

To 5.445 g (11.49 mmol) of the BOMAG-DCC Solution (1.4 mol-%) prepared according to example 8 in a 50 ml Schlenk-flask, 2.878 g 2-ethylhexanol (22.10 mmol) were added dropwise at 0° C. and thereafter stirred at room temperature for 60 minutes. Thereafter, further 0.0234 g (0.113 mmol) of dicyclohexylcarbodiimide (DCC) were added to increase the total amount of DCC added to 2.39 mol-% calculated on magnesium. The viscosity was measured as indicated above and found to be 340.2 mPa*s at 20° C.

### Example 11

To 5.451 g (11.51 mmol) of the (unmodified) BOMAG solution employed to prepare the solution according to example 8 in a 50 ml Schlenk-flask, 2.880 g 2-ethylhexanol (22.12 mmol) were added dropwise at 0° C. and thereafter stirred at room temperature for 60 minutes. Thereafter, 0.0238 g (0.115 mmol) of dicyclohexylcarbodiimide (DCC) or 0.99 mol-% calculated on magnesium were added. The viscosity was measured as indicated above and found to be 504.0 mPa*s at 20° C.

From examples 9 to 11 it is apparent that the addition of compounds of formula (II) are suitable to significantly decrease not only the viscosity of diorganomagnesium compounds but also those of magnesium alcoholates in non-coordinating solvents.

1. Organo-magnesium compounds obtainable by reacting compounds of formula (I) with compounds of formula (II) 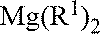 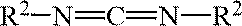
wherein
R¹ each independently of the other residue R¹ present in the compound of formula (I) denotes alkyl which is either not or once substituted by phenyl and
R² each independently of the other residue R² present in the compound of formula (II) denotes alkyl which is either not or once substituted either by optionally substituted phenyl or N(R³)₂, or denotes optionally substituted phenyl or denotes Si(R³)₃, wherein in the aforementioned formulae R³ is alkyl or optionally substituted phenyl.

2. The organo-magnesium compounds according to claim 1, wherein the compounds of formula (I) are selected from the group consisting of n-butyl-n-octyl-magnesium, n-butyl-ethyl-magnesium, n-butyl-sec-butyl-magnesium, di-n-butyl-magnesium, di-n-hexyl-magnesium and di-n-octyl-magnesium.

3. The organo-magnesium compounds according to claim 1, wherein the compounds of formula (II) are selected from the group consisting of N,N′-dicyclohexylcarbodiimide, diisopropylcarbodiimide, 1-ethyl-3-(3-dimethylaminopropyl)carbodiimide, 1,3-bis(trimethylsilyl)carbodiimide, bis(4-methylphenyl)carbodiimide and N,N′-bis(2-methylphenyl)carbodiimide.

4. The organo-magnesium compounds according to claim 1, wherein the reaction is performed in non-coordinating solvents.

5. The organo-magnesium compounds according to claim 4, wherein the non-coordinating solvents are selected from the group consisting of pentanes, hexanes, heptanes, octanes, nonanes, decanes, undecanes, dodecanes, each of the aforementioned in any possible isomeric pure form or in isomeric mixtures, mineral oils or any mixture of the aforementioned aliphatic solvents.

6. The organo-magnesium compounds according to claim 1, wherein the reaction is performed batchwise or continuously .

7. The organo-magnesium compounds according to claim 1, wherein the molar ratio between compounds of formula (I) and compounds of formula (II) is from 1.0 to 200.0 .

8. The organo-magnesium compounds according to claim 1, comprising at least a structural unit of formula (III) or formula (IV) 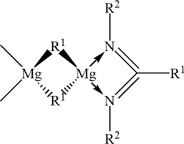 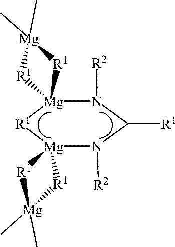
wherein R¹ and R² have the meaning as set forth in the preceding claims, the arrows denote coordinative bonds from magnesium to nitrogen or the amidinate group the other solid, bold or dashed bonds denote covalent bonds or, where magnesium and alkyl residues R¹ are involved a three center two electron bond and wherein at least one of the solid bonds for each magnesium showing no bound element or group is linking to a residue R¹ or both solid bonds are linking to a further chain element MgR¹₂.

9. Solutions of organo-magnesium compounds according to claim 1 in non-coordinating solvents.

10. The solutions according to claim 9, wherein the concentration of the organo-magnesium compounds in the non-coordinating solvents is from 5 to 60 wt.% .

11. A process for the preparation of organo-magnesium compounds or their solutions according as defined in claim 1 by reacting compounds of formula (I) with compounds of formula (II) 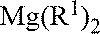 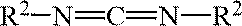
in a non-coordinating solvent and optionally removal of such non-coordinating solvent.

12. A process for the preparation of magnesium alcoholates of formulae (III) and (IV) 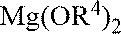 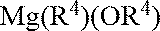
wherein
R⁴ each independently of the other residue R⁴ present in the compounds of formulae (III) and (IV) denotes alkyl which is either not or once substituted by phenyl
the process comprising at least the step of
a) reacting the organo-magnesium compounds or their solutions according to claim 1 with an alcohol, an alcohol of formula (V) 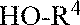
wherein R⁴ has the same meaning as defined for formulae (III) and (IV) above.

13. A process for the preparation of magnesium chloride comprising the steps of
a) reacting the organo-magnesium compounds or their solutions according to claim 1 with an alcohol, an alcohol of formula (V) to obtain the respective magnesium alcoholates, those of formulae (III) or (IV) and
b) reacting the magnesium alcoholates obtained according to step a) with a chloride source to magnesium dichloride, or alternatively the step of
A) reacting the organo-magnesium compounds or their solutions according to claim 1 with a chloride source to magnesium dichloride.

14. Use of compounds of formula (II) according to claim 1 as viscosity modifier of compounds of formula (I) according to claim 1 or magnesium alcoholates, those of formulae (III) and (IV) as defined in claim 12, each of the aforementioned in non-coordinating solvents.

15. Use of organo-magnesium compounds or their solutions according to claim 1 for the preparation of magnesium alcoholates, those of formulae (III) and (IV) or magnesium dichloride.
